(19) United States
(12) Patent Application Publication
(10) Pub. No.: US 2026/0146177 A1
(43) Pub. Date: May 28, 2026

(54) ONE-STEP METHOD FOR MANUFACTURING AN INK COMPRISING AN N-TYPE CONDUCTING POLYMER

(71) Applicant: WESTRA MATERIALS AB, Norrköping (SE)

(72) Inventors: Simone FABIANO, Norrköping (SE); Chi-Yuan YANG, Norrköping (SE); Marc-Antoine STOECKEL, Norrköping (SE); Jun-Da HUANG, Norrköping (SE); Qifan LI, Norrköping (SE)

(73) Assignee: WESTRA MATERIALS AB, Norrköping (SE)

(21) Appl. No.: 19/483,370

(22) PCT Filed: May 17, 2024
(86) PCT No.: PCT/EP2024/063710

§ 371 Date: Nov. 11, 2025

(30) Foreign Application Priority Data
May 17, 2023 (WO) PCT/EP2023/063322

(51) Int. Cl. C09D 11/52; C08G 61/12; C09D 11/54; C09D 165/00

(52) U.S. Cl. CPC C09D 11/52; C08G 61/12; C09D 11/54; C09D 165/00; C08G 2261/3242

(57) ABSTRACT

The present invention relates to a method for manufacturing an ink comprising n-type conducting polymer, said method comprising the steps of: a) providing a catalyst or a catalyst precursor: b) oxidizing said catalyst precursor by means of an oxidizing promoter thus obtaining said catalyst: c) adding a monomer to a solvent system comprising a polar aprotic solvent in the presence of said catalyst, thus providing a reaction solution: d) allowing the monomer to polymerize in said reaction solution thus obtaining an ink comprising n-type conducting polymer, wherein said catalyst is a quinone comprising at least one branched side chain comprising at least one chiral centre.

### TECHNICAL FIELD

The present invention relates to a method for manufacturing an ink comprising an n-type conducting polymer, and an ink comprising the n-type conducting polymer obtained by such a method.

### BACKGROUND OF THE INVENTION

Conductive polymers (CPs) have attracted widespread attention due to their multifunctional properties, including flexibility, low-cost solution processability, and electrochemical redox activity. These characteristics make CPs suitable in broad application prospects in the electronics field, especially in flexible electronics, wearable technology, flexible displays, etc. Anong CPs, PEDOT: PSS has become one of the most studied substance due to its excellent electro-optical properties and high conductivity. It can achieve conductivity exceeding 1000 S cm⁻¹ after secondary doping.

In general, PEDOT can be prepared by polymerization using chemical oxidation or electrochemical processes. Preparation of PEDOT via a chemical oxidation process results in higher yields and requires no special setup. Although PEDOT is highly conductive, it is insoluble in water, making it difficult to process. However, this problem can be solved by using polyelectrolytes such as polystyrene sulfonic acid (PSS), which act as dopants and stabilizers for PEDOT through charge balancing. PEDOT: PSS has good transparency, low density, low thermal conductivity, high thermal stability, good compatibility, flexibility and low production cost. It has diverse applications in flexible electronics, organic solar cells, supercapacitors, electrochemical transistors, and light-emitting diodes. However, achieving superior performance in many of these applications requires devices that use both hole-transporting (p-type) and electron-transporting (n-type) materials.

In recent years, significant progress has been made in the development of high-performance n-type conductive polymers, but the synthesis processes of some n-type conductive polymers have lower yields, thus reducing cost-efficiency. Further, the synthesis of n-type conductive polymers requires the use of toxic solvents, which is harmful to the environment and the health of operators.

CN 115651448 describes synthesis of an n-type conductive polymer poly(benzodifurandione) (PBFDO), which is known for its excellent conductivity. However, the synthetic route disclosed in CN 115651448 requires about 2 weeks of dialysis post-treatment, and the polymerization step uses non-recyclable catalysts derived from fossil resources.

Therefore, there is a need for developing an improved method for manufacturing an ink comprising n-type conducting polymers, in particular involving renewable and environmentally friendly catalysts.

### SUMMARY OF THE INVENTION

Considering the above, the present invention aims to solve the problems of the prior art. To this end, the present invention relates to a method for manufacturing an ink comprising n-type conducting polymer, the method comprising the steps of:
a) providing a catalyst or a catalyst precursor;
b) oxidizing the catalyst precursor by means of an oxidizing promoter thus obtaining the catalyst;
c) adding a monomer to a solvent system comprising a polar aprotic solvent in the presence of the catalyst, thus providing a reaction solution;
d) allowing the monomer to polymerize in the reaction solution thus obtaining an ink comprising n-type conducting polymer.

The catalyst is a quinone comprising at least one branched side chain and at least one chiral centre arranged on the at least one branched side chain. The catalyst precursor is a quinone precursor, i.e. a species that is able to form a quinone structure. The side chain may comprise from 3 to 100 carbon atoms. The side chain may further comprise at least one functional group, e.g. a hydroxyl group. Further, the side chain may further comprise a branch centre. It has been shown that the catalyst according to the present invention does not crystallize during the polymerisation reaction, since the at least one branched side chain comprising at least one chiral centre prevents such a crystallization. Since the catalyst does not crystallize, the dialysis step is eliminated.

It must be noted that step b) is indeed omitted when a catalyst is provided in step a). If present, step b) may occur before or simultaneously with step c).

The term “oxidizing promoter” refers to a species or a method that is able to induce oxidation.

Thus, one of the advantages of the method of the present invention is that dialysis step in order to remove the catalyst is eliminated, since the catalyst according to the present invention does not crystallize due to the presence of at least one branched side chain comprising at least one chiral centre.

The monomer has the central symmetrical benzene ring as the skeleton, active hydrogen and at least one electron-withdrawing group at the benzylic position. The electron-withdrawing groups may be carbonyl, carboxyl, amide, alkoxy acyl or the like.

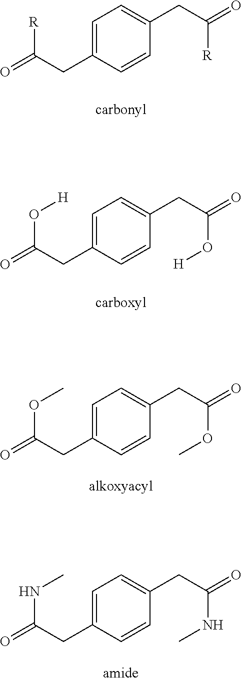

Further, the monomer may be in the form of a heterocyclic moiety having a central symmetrical benzene ring fused with at least one, preferably at least two rings, preferably five-membered rings. The monomer further comprises an active hydrogen and at least one electron-withdrawing group at the benzylic position. In particular, the monomer may be 3,7-dihydrobenzo[1,2-b: 4,5-b′]difuran-2,6-dione (HBFDO), 5,7-dihydropyrrolo[2,3-f]indole-2,6(1H,3H)-dione, or 3,7-dihydrobenzo[1,2-b: 4,5-b′]dithiophene-2,6-dione.

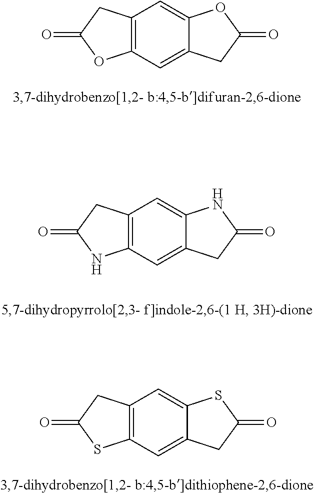 [SMILES: O=C1Cc2cc3c(cc2O1)CC(=O)O3 ; O=C1Cc2cc3c(cc2N1)CC(=O)N3 ; O=C1Cc2cc3c(cc2S1)CC(=O)S3]

In particular, the monomer is 3,7-dihydrobenzo[1,2-b: 4,5-b′] difuran-2,6-dione (HBFDO). In such an embodiment, the n-type conducting polymer is poly(benzodifurandione) (PBFDO).

According to a particular embodiment, the catalyst precursor may be Vitamin E. As commonly known in the art, Vitamin E is a group of eight fat soluble compounds that include four tocopherols and four tocotrienols, as illustrated below:

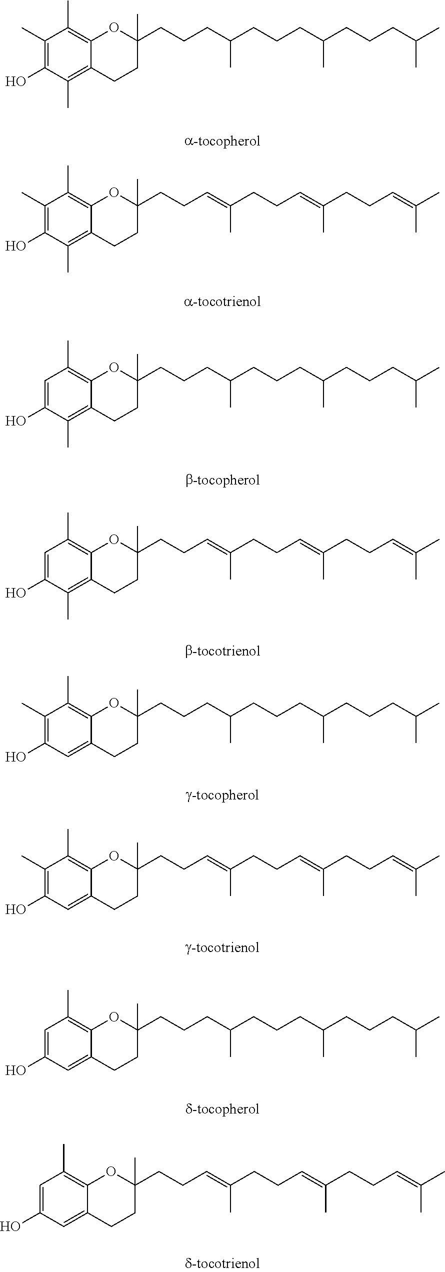

It should be noted that according to the present invention, the term Vitamin E implies at least one of the species above. In other words, each of the species above may be present in its pure form in the reaction solution, or at least two of the species above may be present in any combination. Consequently, vitamin E may be selected from a group consisting of: α-tocopherol, β-tocopherol, γ-tocopherol, δ-tocopherol, α-tocotrienol, β-tocotrienol, γ-tocotrienol, δ-tocotrienol and mixtures thereof.

Vitamin E (generic term for tocopherols and tocotrienols) is a natural product with high redox activity. Vitamin E can be synthesized in plants that undergo photosynthesis, and it can be extracted in large quantities from plants. All vitamin E molecules have branched long hydrocarbon side chains, and they are natural oily substances with no crystallinity at room temperature. According to the method of the present invention, vitamin E may be used as catalyst precursor to synthesize ink comprising n-type conducting polymer in one step or in one-pot without the need for post treatment, such as dialysis and solvent removal. Compared with the three-step method reported in the prior art document identified above, the method of the present invention achieves a great simplification.

It has been surprisingly shown that vitamin E itself has no catalytic effect, but the oxidized form of vitamin E does. In the presence of an oxidizing promoter, vitamin E forms a benzoquinone derivative. As mentioned above, oxidation of vitamin E may be performed before addition of the monomer. Alternatively, oxidation of vitamin E may occur in-situ during step c). Once the catalyst, e.g. the oxidized vitamin E, comes in contact with the monomer, polymerisation reaction is initiated. The method of the present invention thus offers the advantage of a simplified and cost-efficient method for manufacturing an ink comprising n-type conducting polymer compared to the methods known in the art. A great advantage of using Vitamin E as catalyst precursor is its availability, low price and non-toxicity.

The at least one branched side chain of the catalyst according to the present invention may be a saturated branched side chain.

It should be noted that catalyst may also be referred to as initiator, in particular when used in polymerizations.

In a particular embodiment, the polar aprotic solvent is DMSO, and the oxidizing promoter is hydrogen bromide (HBr). The HBr is volatile and does not affect film formation when the ink is printed. DMSO may be an industrial grade DMSO, i.e. it may comprise water.

Alternatively, the oxidizing promoter is an ionic liquid comprising a cation and an anion. In such an embodiment, the method further comprises a step of:
a′) electrolysing the reaction solution,
wherein the step a′) occurs simultaneously with or after step c). In such an embodiment, oxidation is an electrochemical oxidation.

In particular, the step a′) may occur using a nickel cathode and a carbon anode under voltage in the range from 4 to 6 V for a period in the range from 10 to 60 min.

The cation in the ionic liquid may be selected from a group consisting of 1-ethyl-3-methylimidazolium (EMIM), 1-butyl-3-methylimidazolium (BMIM), 1-allyl-3-methylimidazolium (AMIM), 1-hexyl-3-methylimidazolium (HMIM), butyl-methyl pyrrolidinium (BMP), propyl-methyl pyrrolidinium (PMP), triethyl sulfonium and mixtures thereof. The structures of the cations are shown below.

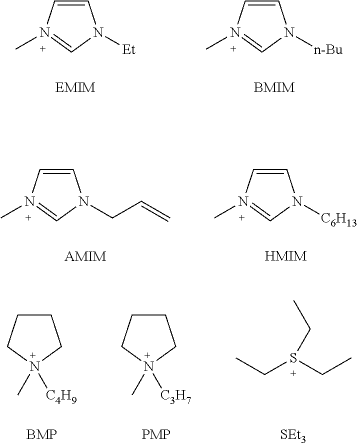

According to the present invention, the anion may be selected from a group consisting of chloride (Cl⁻), bromide (Br⁻), iodide (I⁻), acetate (OAc), tetrafluoro borate (BF₄⁻), hexafluoro phosphate (PF₆⁻), bis-trifluoromethanesulfonimide (TFSI), trifluoromethanesulfonate (OTf), dicyanamide (DCA), hydrogen sulphate (HSO₄⁻), ethyl sulphate (ESO₄⁻), thiocyanate (SCN), tosylate (OTs), mesylate (OMs), tetrachloro aluminate (AlCl₄⁻), diethyl phosphate (DEP), dimethyl phosphate (DMP), lactate (La), L-alanine anion (APP) and mixtures thereof. The structures of the anions are illustrated below.

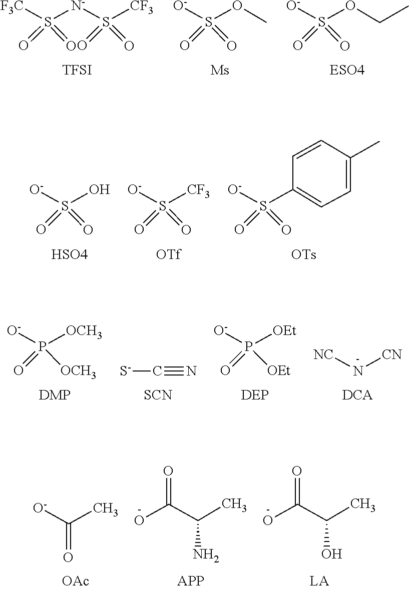

As mentioned above, the solvent system according to the method of the present invention comprises a polar aprotic solvent. The polar aprotic solvent may be dimethyl sulfoxide (DMSO), dimethyl formamide (DMF), dimethyl acetamide (DMA) or a combination thereof.

The ratio between the oxidizing promoter and the vitamin E in step b) may be in the range from 0.1 to 100, preferably from 0.25 to 5, more preferably from 1 to 3.

The polymerisation reaction, i.e. step d) of the method of the present invention, may occur at a temperature from 5° C. to 200° C., preferably from 18° C. to 180° C.

The polymerisation reaction, i.e. step d) of the method of the present invention, may occur during a period of time from 10 min to 72 h. For instance, when step d) was performed at 100° C., the reaction was completed after 1 h, as indicated by the colour change of the reaction solution and by observing the viscosity. On the other hand, when step d) was performed at room temperature, colour change was observed after approximately 72 h. The reaction solution in the beginning of step d) may have a temperature of 25° C., and may subsequently be raised until it reaches a value of 100° C. Alternatively, the reaction solution in the beginning of step d) may have a temperature of 100° C., and may be maintained throughout the entire step d).

Steps a)-d) of the method according to the present invention may be performed in ambient conditions, i.e. in air at a temperature of 20-25° C. Preferably, at least step d) is performed in an inert atmosphere, i.e. under nitrogen or argon.

In order to improve cost efficiency of the method according to the present invention even further, the method according to the present invention may further comprise a step of:

e) removing the catalyst by extraction and recycling the catalyst.

The extraction may be performed using alkanes or ethers.

The general overview of the method of the present invention may be summarized as follows:

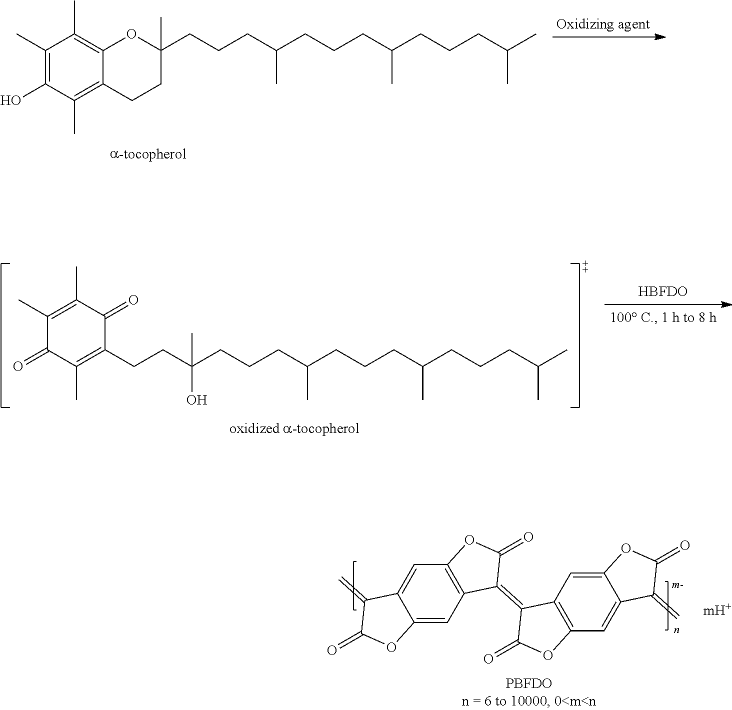

The present invention further relates to an ink comprising an n-type conducting polymer, wherein the ink is manufactured by the method as described above.

The n-type conducting ink of the present invention may be deposited by means of spin coating, drop casting, inkjet printing or screen printing. Deposition may be performed in air and ambient temperature, forming the film having thicknesses from 1 nm to 1 cm, more preferably from 10 nm to 1 μm. Such a film may exhibit electrical conductivity in the order of at least 10, preferably at least 1000 S/cm, more preferably at least 5000 S/cm.

The n-type conducting ink of the present invention may be shear-thinning. In particular, when PBFDO content in the n-type conducting ink is 0.67 wt %, a viscosity range may be in the interval from 0.007 to 32 Pa·s. Higher values of viscosity may be obtained at higher weight contents and/or lower shear rates.

As mentioned above, the n-type conducting ink according to the present invention may be used in an organic optical or electronic device, such as OECTs, thermoelectric devices, ternary logic inverters, OPVs, OLEDs, organic supercapacitors, batteries, fuel cells, sensors and memories.

### BRIEF DESCRIPTION OF THE DRAWINGS

Embodiments of the invention will now be described by way of example with reference to the accompanying drawings, of which:

FIG. 1 shows the steps of the method according to the first embodiment of the present invention;

FIG. 2 shows 2D Transmission WAXS pattern of TMQ (a) and OVE (b), 1D line cuts of TMQ (c) and OVE (d), and photographs of TMQ (e) and OVE (f);

FIG. 3 illustrates photographs of TMQH (a) and VE (b);

FIG. 4 illustrate electrical properties-(a) optimized PBFDO (OVE) conductivity based on different OVE equivalent and the same monomer concentration 15 mg mL⁻¹, (b) optimized PBFDO (OVE) conductivity based on different monomer concentration and the same OVE equivalent of 1.5 eq., (c) electrical conductivity of PBFDO (TMQ) and PBFDO (OVE) for different post-processing methods; (d) normalized PBFDO (OVE) as-polymerized thin film conductivity as a function of time stored at ambient, (e, f) Seebeck coefficient measurement of dialyzed PBFDO (TMQ) and dialyzed PBFDO (OVE);

FIG. 5 depicts thermogravimetric analysis (TGA)—(a) TGA of dialyzed PBFDO (TMQ), (b) TGA of dialyzed PBFDO (OVE), (c) TGA of TMQ, (d) TGA of OVE, (e) TGA of PBFDO (TMQ), (f) TGA of PBFDO (OVE);

FIG. 6 shows differential scanning calorimetry (DSC) curve of polymers under nitrogen flow at heating/cooling rates of 10/10° C. min-1;

FIG. 7 depicts Seebeck coefficient measurement of PBFDO (TMQ) and PBFDO (OVE);

FIG. 8 illustrates spectroscopic confirmation—(a) FTIR spectra of dialyzed PBFDO (TMQ), dialyzed PBFDO (OVE) and non-dialyzed PBFDO (OVE), (b) UV-vis spectra of dialyzed PBFDO (TMQ), dialyzed PBFDO (OVE) and non-dialyzed PBFDO (OVE), (c, e) XPS spectra of dialyzed PBFDO (TMQ), (d, f) XPS spectra of dialyzed PBFDO (OVE);

FIG. 9 depicts FTIR spectra—(a) FTIR spectra illustrating PBFDO with and without TMQ to demonstrate the absence of TMQ/TMQH after dialysis in PBFDO (b) FTIR spectra displaying PBFDO with and without OVE to show the absence of OVE/VE after dialysis in PBFDO;

FIG. 10a-d show 2D GIWAXS patterns of thin films comprising PBFDO (TMQ) as-polymerized (a), PBFDO (TMQ) dialyzed (b), PBFDO (OVE) as-polymerized (c), PBFDO (OVE) dialyzed (d);

FIG. 10e, f depict corresponding 1D line cuts in the (e) out-of-plane and (f) in-plane direction;

FIG. 10g-j show atomic force microscope (AFM) height images of thin films comprising PBFDO (TMQ) as-polymerized (g), PBFDO (TMQ) dialyzed (h), PBFDO (TMQ) as-polymerized (i), and PBFDO (OVE) dialyzed (j);

FIGS. 11 and 12 illustrate GIWAXS analysis;

FIG. 13 shows a schematic diagram and photograph of scale up production.

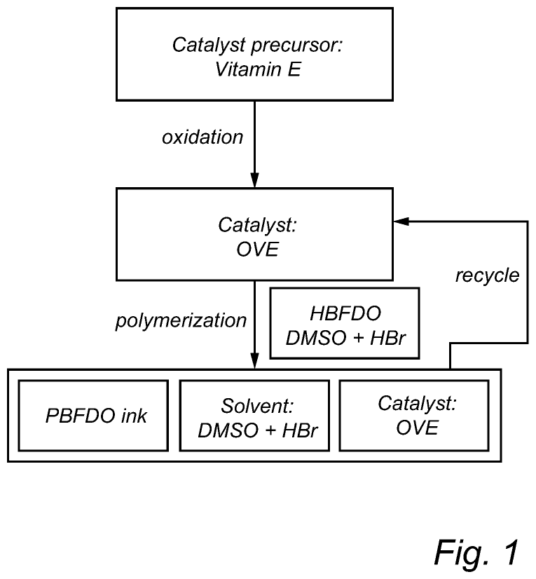

### DETAILED DESCRIPTION OF THE INVENTION

As mentioned above, the present invention relates to a method for manufacturing an ink comprising n-type conducting polymer, the method comprising the steps of:
a) providing a catalyst or a catalyst precursor;
b) oxidizing the catalyst precursor by means of an oxidizing promoter thus obtaining the catalyst;
c) adding a monomer to a solvent system comprising a polar aprotic solvent in the presence of the catalyst, thus providing a reaction solution;
d) allowing the monomer to polymerize in the reaction solution thus obtaining an ink comprising n-type conducting polymer, wherein the catalyst is a quinone comprising at least one branched side chain comprising at least one chiral centre.

In an exemplary embodiment, a method using the catalyst 2-(3-hydroxy-3,7,11,15-tetramethylhexadecyl)-3,5,6-trimethylcyclohexa-2,5-diene-1,4-dione (OVE) for the polymerization of 3,7-dihydrobenzo[1,2-b: 4,5-b′] difuran-2,6-dione (HBFDO) in DMSO is described.

Tetramethyl-1,4-benzoquinone (TMQ) was purchased from Tokyo Chemical Industry (TCI). 1,4-Benzoquinone (BQ), ethyl cyanoacetate, absolute ethanol, ammonia solution 28%, hydrochloric acid 37%, activated charcoal, toluene, acetic anhydride, chloroform, rac-alpha-Tocopherol (VE), diethyl ether, iron (III) chloride hexahydrate and methanol were purchased from Sigma-Aldrich and were used without further purification.

### Syntheses

### Synthesis of HBFDO

3,7-dihydrobenzo[1,2-b: 4,5-b′] difuran-2,6-dione (HBFDO) was synthesized following a reported procedure. In brief, two dropping funnels were installed on the three-necked flask A. The three-necked flask A should be placed in circulating water that ensures constant temperature. Ethyl cyanoacetate (21.26 g, 20 mL, 187.94 mmol), ethanol (66 mL) and concentrated ammonium hydroxide (15.01 g, 16.66 mL, 431.35 mmol) were added to flask A. Meanwhile, benzoquinone (36 g, 333.04 mmol) and ethanol (266 mL) were added to round-bottomed flask B, stirred at 40° C. degrees for 30 min, then ethyl cyanoacetate (37.51 g, 35.29 mL, 331.61 mmol) was added to flask B, and the mixture was then transferred from flask B to one of the dropping funnels on the three-necked flask A while hot. Concentrated ammonium hydroxide (60.32 g, 66.6 mL, 1724.37 mmol) was diluted with 100 mL of water and poured into the other dropping funnel. The two dropping funnels were opened at the same time, and the dropping speed was adjusted such that when 10% of the benzoquinone solution still remains, the entire amount of the ammonia solution have been added. The entire dripping time was about 30 minutes. The resulting purple-red precipitate was stirred for another hour. Then, the solid was collected by suction filtration, washed with a large amount of ethanol and dried to get compound 1 (22.13 g, 20% yield) as dark purple solid.

During the next step (hydrolysis), compound 1 (25 g, 75 mmol), concentrated hydrochloric acid (172.5 g, 145 mL, 1750 mmol) and water (130 mL) were added to a round-bottomed flask and refluxed at 110° C. overnight. Water (125 mL) and activated charcoal (5 g) were added to the hot reaction mixture, boiled for an additional 5 min, filtered through a funnel to remove the activated carbon, and washed with a small amount of hot water. The filtrate was cooled to obtain white crystalline solid 2 (12.25 g, 72% yield).

During the last step, the crystalline solid 2 (16 g, 70.74 mmol) was dissolved in anhydrous toluene (800 mL), acetic anhydride (172.8 g, 160 mL, 1690 mmol) was added. The mixture was stirred at 100° C. overnight and the solvent was removed under vacuum. The residue was dispersed in methanol and filtered. Acetonitrile was added to the filtered residue and the mixture was stirred at 90° C. to completely dissolve the solid residue. The solution is placed in an ice bath for crystallization and filtered to give HBFDO as white crystals (12.11 g, 90%).

### Synthesis of Catalyst Oxidized Vitamin E (OVE)

Tocopherol (10 g) was dissolved in diethyl ether (100 mL) and mixed with ferric chloride hexahydrate solution (2 g in 25 mL of methanol/water, 50/50, V/V). After 30 min of stirring the organic phase was collected and subjected to reaction with ferric chloride hexahydrate solution again. The procedure was repeated five times, then the organic phase was washed with water three times and dried over sodium sulfate. The solvent was removed in a rotary evaporator at 40° C. to give the final product as yellow oil (9.4 g, 91%).

### Synthesis of PBFDO

3,7-dihydrobenzo[1,2-b: 4,5-b′] difuran-2,6-dione (HBFDO, 3.18 g, 16.72 mmol) and oxidized vitamin E (11.21 g, 25.08 mmol) were dissolved in 212 mL DMSO under nitrogen. The resulting mixture was heated to 100° C. and stirred for 1 h to obtain a PBFDO (OVE) ink with a solid content of approximately 0.5 mg mL⁻¹.

Synthesis of PBFDO using TMQ was performed following the procedure in Tang et el., Nature, 2022 November; 611 (7935): 271-277.

### Thin-Film Casting

PBFDO (TMQ) and PBFDO (OVE) films were spin-cast (1500 rpm, 120 s, acceleration 1500 rpm s⁻¹, then 3000 rpm, 10 s, acceleration 3000 rpm s⁻¹) onto glass, Si or Si/SiO₂ substrates, the films were then placed on a hot plate at 40° C. to dry.

### Absorption Spectra

Films comprising PBFDO (TMQ)-dialyzed ink and PBFDO (OVE)-dialyzed ink were prepared on glass substrates by spin-coating. The UV-Vis-near infrared spectra were measured by Perkin Elmer Lambda 900. All the FTIR samples except VE and OVE were prepared by evaporating solvent to form solid samples on a 70° C. hotplate and measured using PerkinElmer Spectron 3 FT-IR spectrometer in ATR mode. VE and OVE are used directly for testing and do not require preparation.

### XPS Spectroscopy

The samples were deposited in ambient on Au substrates by drop-casting, and then quickly transferred into the load lock chamber of the ultrahigh vacuum (UHV) system for the following steps. XPS was performed with a Scienta-200 hemispherical analyzer using a monochromatized Al Kα source with a photon energy of 1486.6 eV. The measurements were carried out with a base pressure lower than 1×10⁻⁹ mbar.

### Grazing-Incidence Wide-Angle X-Ray Scattering (GIWAXS) and AFM Characterization

GIWAXS experiments were performed following the previous procedure. All samples for GIWAXS measurements were deposited on cut silicon wafers. The samples were measured at Beamline 9A in the Pohang Accelerator Laboratory in South Korea. The X-ray energy was 11.08 eV and the incidence angle was 0.12°. Samples were measured in vacuum and the total exposure time was 10 s. The scattered X-rays were recorded by a charge-coupled device detector located 220.8498 mm from the sample. AFM images were recorded with an Icon XR from Bruker, using a silicon nitride cantilever with a spring constant of 40 N m⁻¹.

### Electrical Characterization

Electrical conductivity was measured by four-point probe technology using a Keithley 4200-SCS semiconductor characterization system. The conductivity was calculated by the following formula:

$$σ = \frac{I \cdot L}{V \cdot W \cdot d}$$

where W is the sample width, d is the film thickness, and L is the length between two electrodes. Here, W=7 mm, L=3 mm, d depends on different samples.

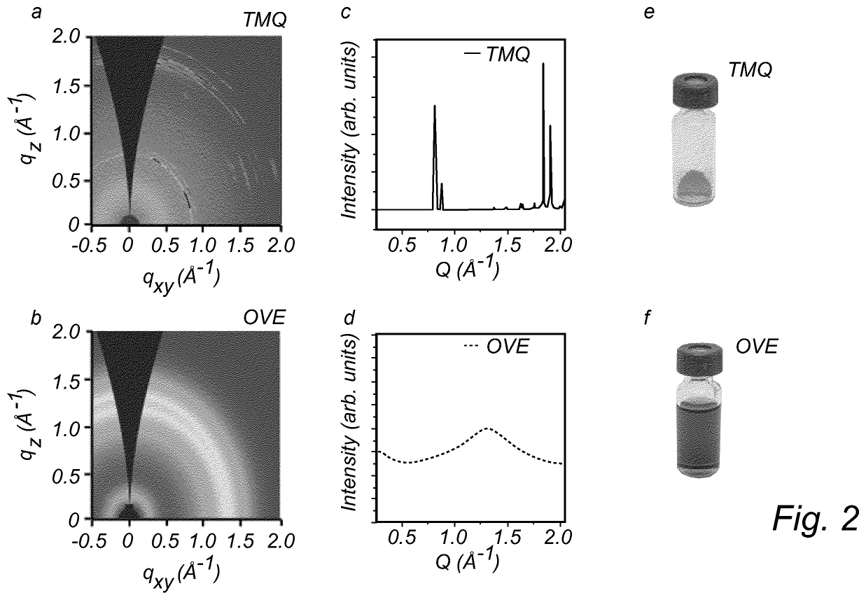

As mentioned above, TMQ exhibits a high degree of crystallinity (FIG. 2c, e, g). In CN 115651448, it was noted that TMQ, when employed as a catalyst in the synthesis of PBFDO, necessitated dialysis to eliminate the catalyst and enhance conductivity. However, dialysis demands a substantial volume of solvent DMSO and a prolonged duration (two weeks), rendering it unsuitable for efficient batch production. Subsequent investigation revealed that numerous quinones possess catalytic potential in PBFDO polymerization.

The inventors mitigated the crystallinity of the catalyst by addition of at least one saturated branched side chain. (rac)-α-Tocopherol (VE), a hydroquinone featuring lengthy alkyl side chains, proved promising. Following a one-step oxidation process, benzoquinone OVE with extended alkyl side chains was synthesized.

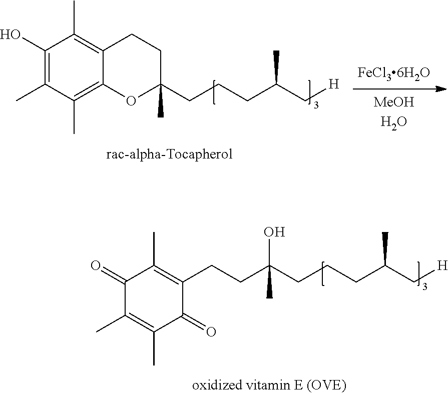

Remarkably, OVE exhibited robust catalytic activity in HBFDO polymerization.

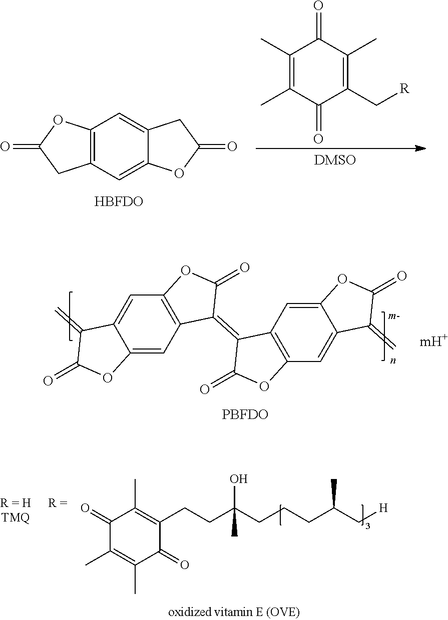

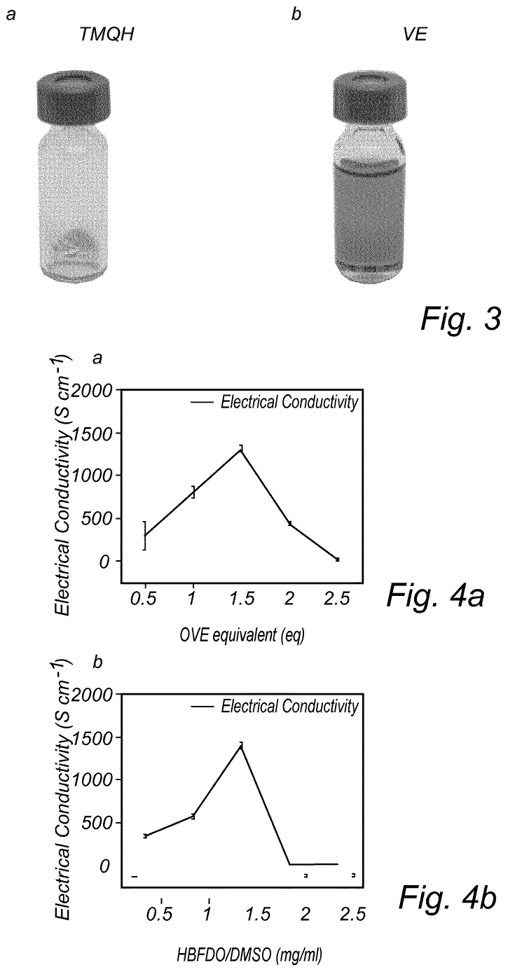

Being oily in nature (FIG. 2d, f, h), OVE obviates the need for dialysis and can be retained within the product, yielding PBFDO with elevated conductivity. During the catalytic polymerization of PBFDO by TMQ and OVE, part of the catalyst will be oxidized into TMQH and VE respectively (FIG. 3).

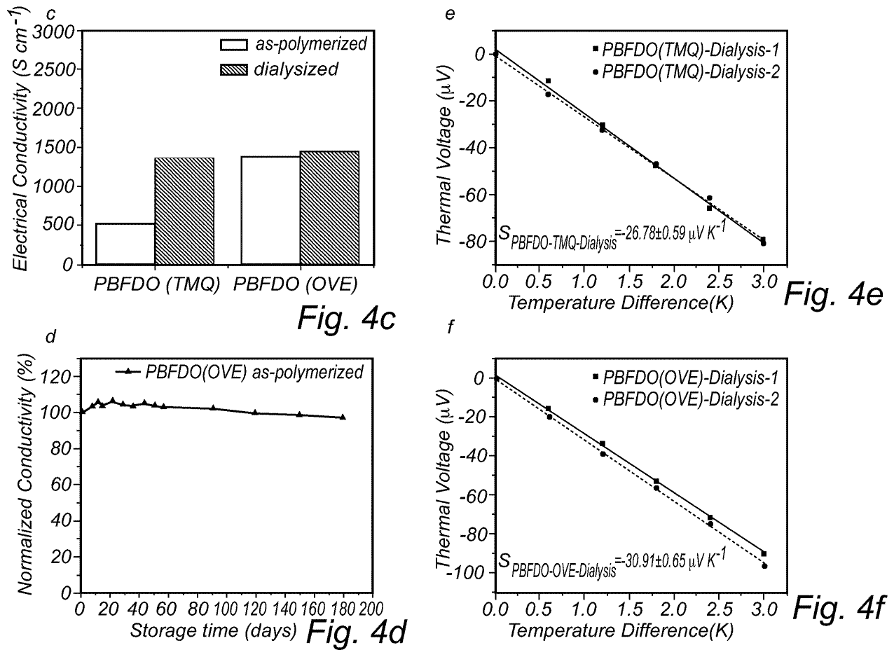

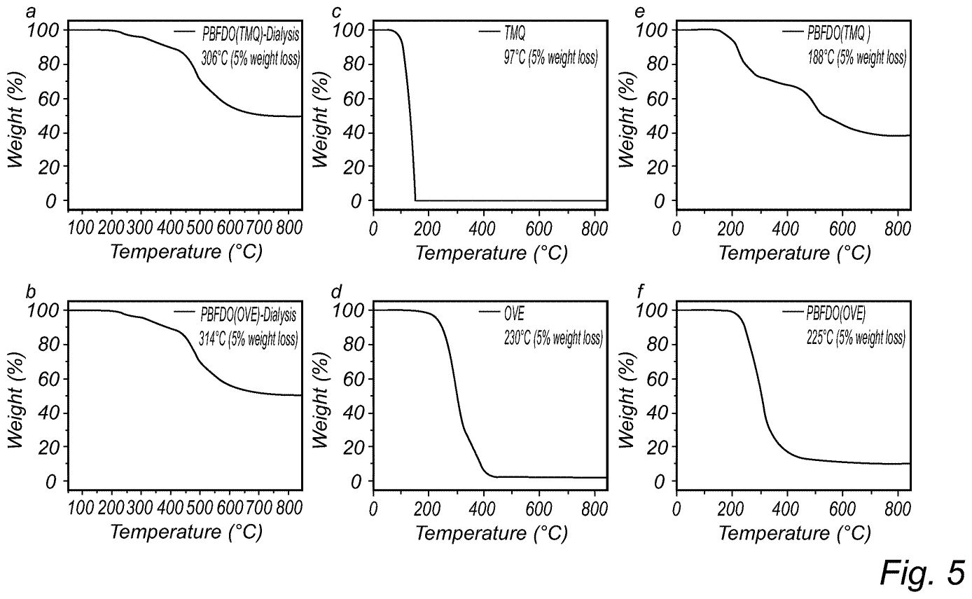

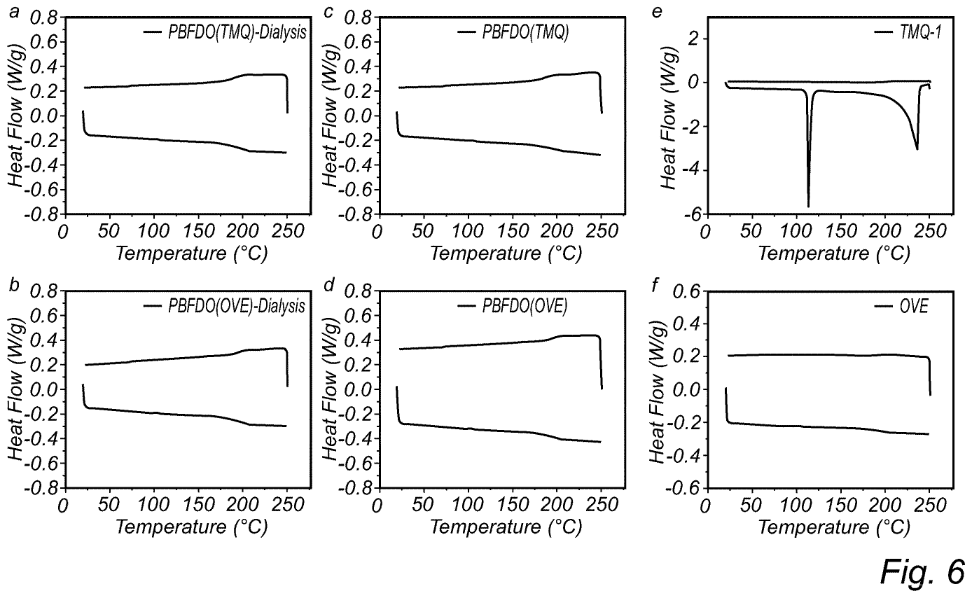

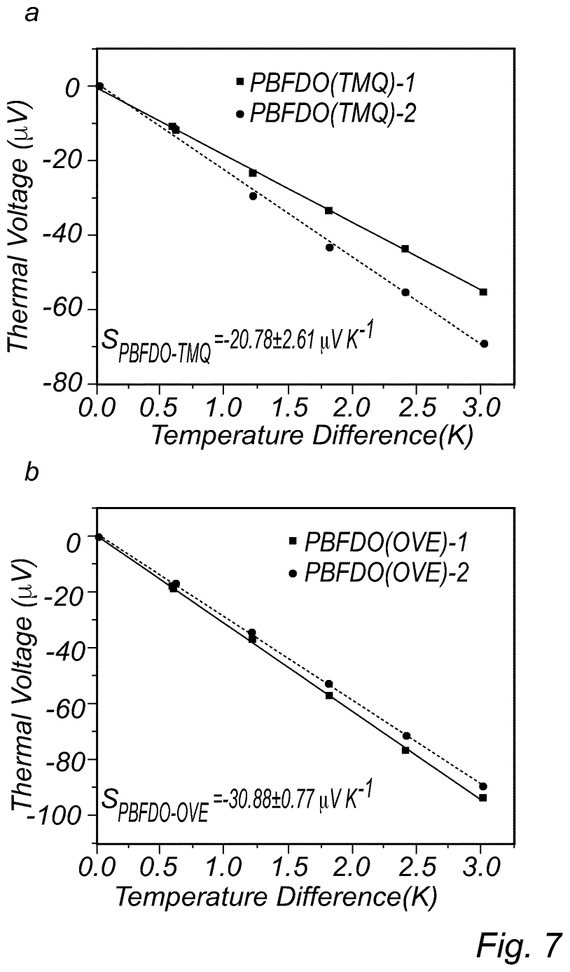

The electrical and thermoelectric properties of PBFDO synthesized by different catalysts were investigated and compared. The electrical conductivity of films prepared with non-dialyzed PBFDO (TMQ)-ink and dialyzed PBFDO (TMQ)-ink is significantly different (509 S cm⁻¹ and 1332 S cm⁻¹, respectively). However, the electrical conductivity of non-dialyzed and dialyzed PBFDO (OVE) films is similar (1320 S cm⁻¹ and 1340 S cm⁻¹, respectively) (FIG. 4c). This indicates that PBFDO (OVE) can provide good electrical properties without dialysis treatment. On the contrary, electrical properties of non-dialyzed PBFDO (TMQ) make it unsuitable for direct applications as conducting ink. PBFDO (OVE) shows excellent stability, retaining 97% of its initial conductivity even after being exposed to air for 180 days (FIG. 4d). Additionally, PBFDO (OVE) demonstrates good thermal stability (FIG. 5) and no observable phase transition, since no curves in FIG. 6 exhibited an obvious exothermic or endothermic behavior in the range of 25˜250° C. The Seebeck coefficient of dialyzed PBFDO (OVE) was tested to be −30.91±0.65 μV K⁻¹ (FIG. 4e). The Seebeck coefficient of dialyzed PBFDO (TMQ) was determined to be −26.78±0.59 μV K⁻¹, indicating a lower value compared to dialyzed PBFDO (OVE). The negative value indicates the n-type character of these polymers.

It was also discovered that the Seebeck coefficient of non-dialyzed PBFDO (TMQ) decreased by 22% in comparison to the dialyzed version, whereas the Seebeck coefficient of non-dialyzed PBFDO (OVE) remained essentially unaltered relative to the dialyzed version (FIG. 7). The negative value indicates the n-type character of these polymers.

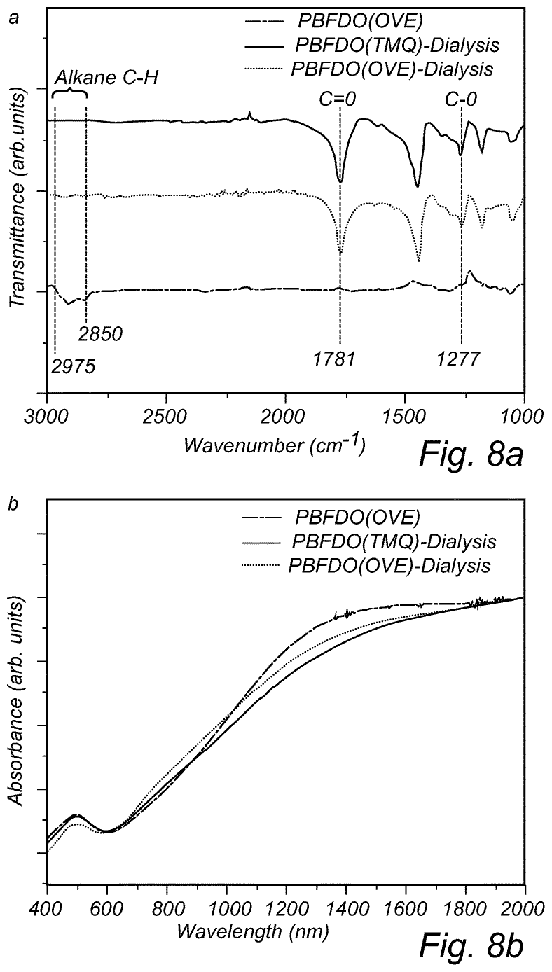

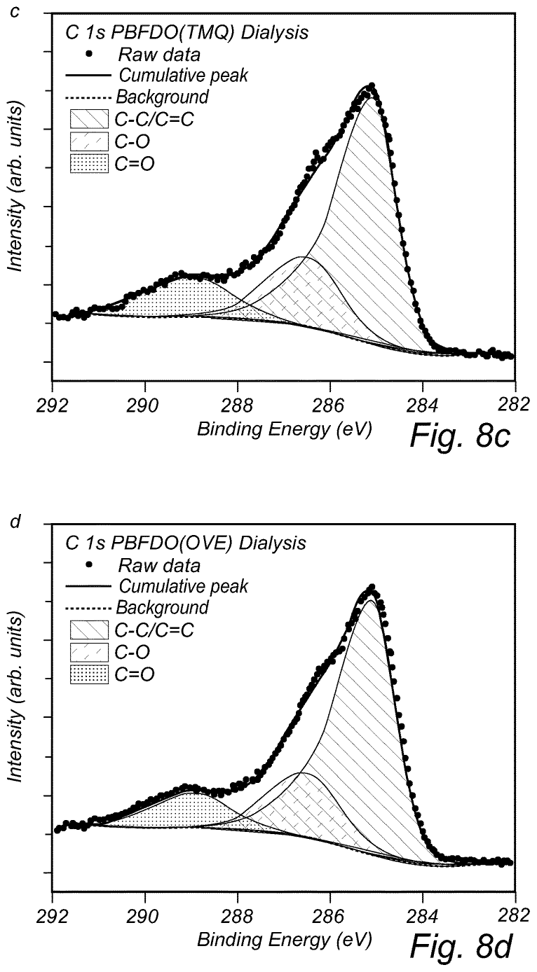

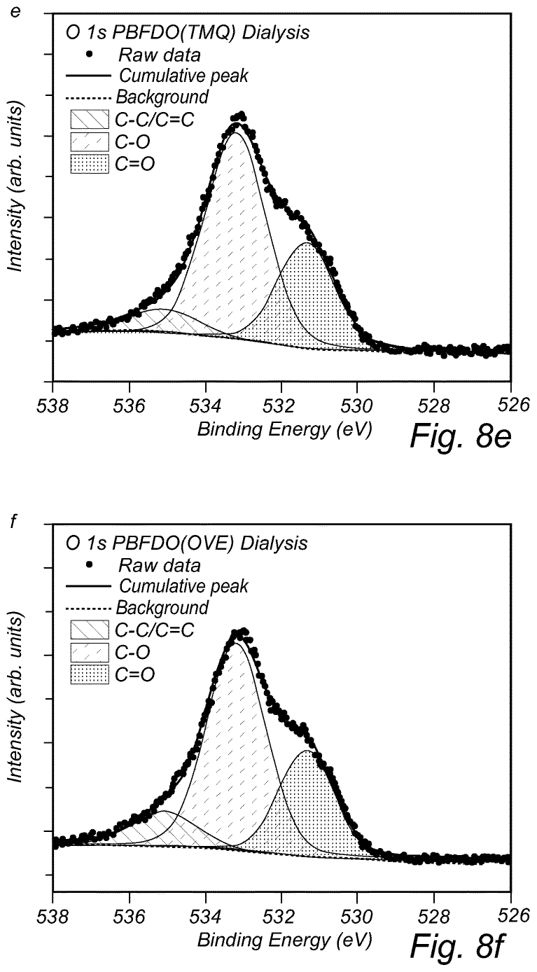

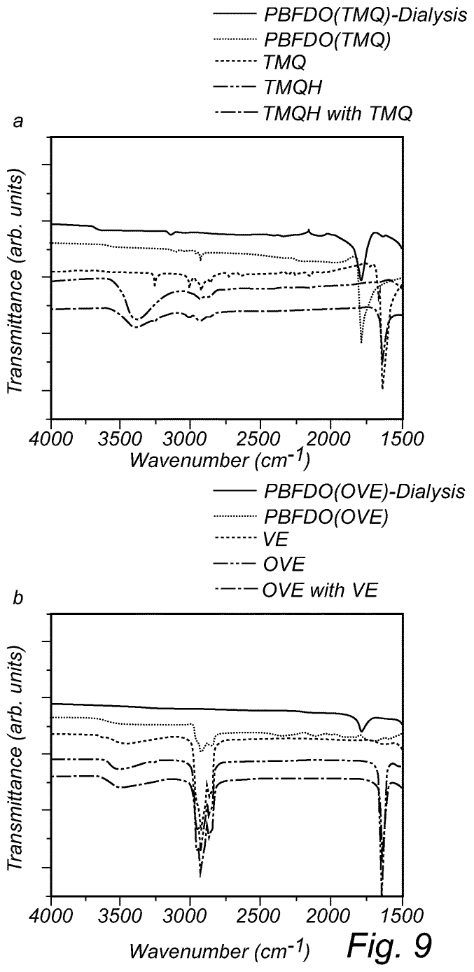

The chemical structure of PBFDO (OVE) was analyzed and compared with dialyzed PBFDO (TMQ). The FTIR spectrum of PBFDO (OVE) revealed several distinctive features in contrast to dialyzed PBFDO (TMQ) (FIG. 8a). In dialyzed PBFDO (TMQ), prominent peaks corresponding to the C═O stretching of the lactone group at 1781 cm⁻¹ and a discernible C—O signal at 1277 cm⁻¹ were evident. Conversely, PBFDO (OVE) lacked distinct peaks in the same region. Additionally, PBFDO (OVE) exhibited a noticeable alkane C—H signal between 2850 cm⁻¹ and 2975 cm⁻¹, corresponding to the alkyl chain in OVE. However, after dialysis, PBFDO (OVE) displayed signals consistent with those of dialyzed PBFDO (TMQ) between 3000 cm⁻¹ and 1000 cm⁻¹, which can partially elucidate that OVE catalyzed polymerization does indeed yield PBFDO. Furthermore, characterization of PBFDO (TMQ) without dialysis, along with the two catalysts TMQ and OVE, and their corresponding reduction products TMQH and VE generated during the catalytic reaction were conducted (FIG. 9). They also have similar characteristics in the UV-Vis spectrum between 350 nm and 2000 nm (FIG. 8b). To further verify that OVE-catalyzed polymerization produces the same PBFDO polymer as TMQ-catalyzed polymerization, X-ray photoelectron spectroscopy (XPS) was utilized to analyze the chemical structure of dialyzed PBFDO (OVE). In the C (1S) spectrum of dialyzed PBFDO (TMQ) C—C/C=C appear at 285.1 eV, C—O at 286.6 eV, and C═O at 289.1 eV (Figure. 8c, d). Dialyzed PBFDO (OVE) exhibited completely consistent binding energies for each peak. Similarly, in the O (1S) spectrum of dialyzed PBFDO (TMQ) C═O appears at 531.4 eV, C—O—C at 533.2 eV, and C═O—H⁺ at 535.1 eV (FIG. 8e, f). Dialyzed PBFDO (OVE) displayed entirely consistent binding energies for each peak as well.

Based on the analysis of the above FTIR, UV-Vis, XPS data and elemental analysis data (Table 1), it is proposed that the chemical structures of PBFDO synthesized through OVE catalysis and TMQ catalyzed synthesis are identical.

TABLE 1
Elemental analysis of dialyzed PBFDO(TMQ)
and dialyzed PBFDO(OVE)

| | Experimental (%) | | |
|---|---|---|---|
| Product | C | H | O |
| PBFDO(TMQ)-Dialysis | 59.35 | 2.04 | 38.42 |
| PBFDO(OVE)-Dialysis | 60.57 | 2.37 | 36.63 |

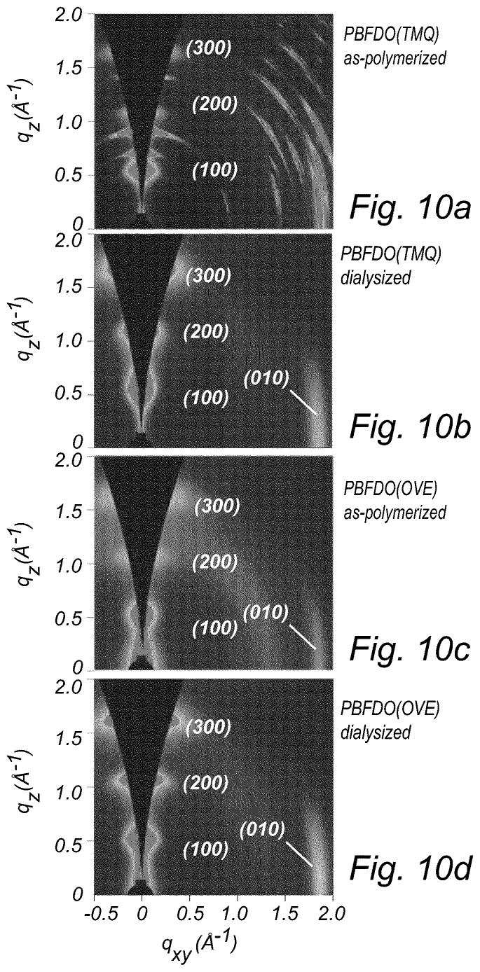

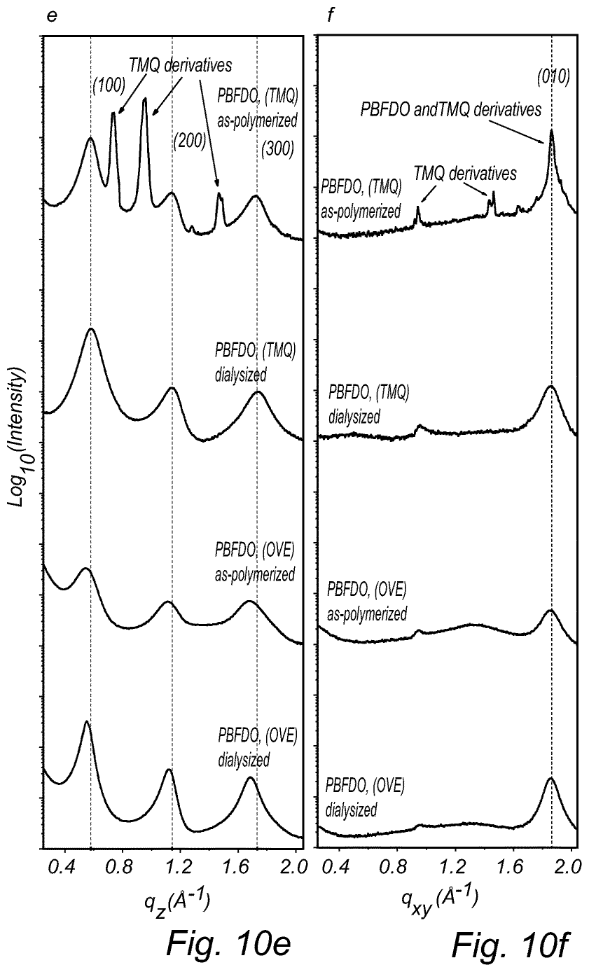

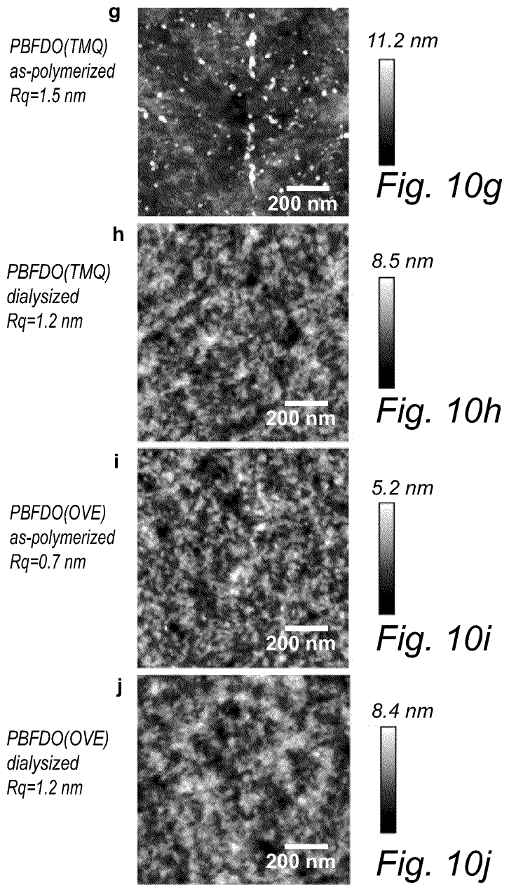

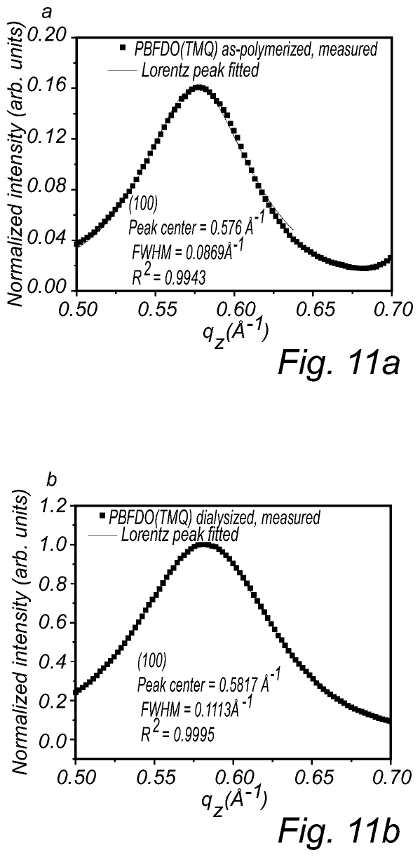

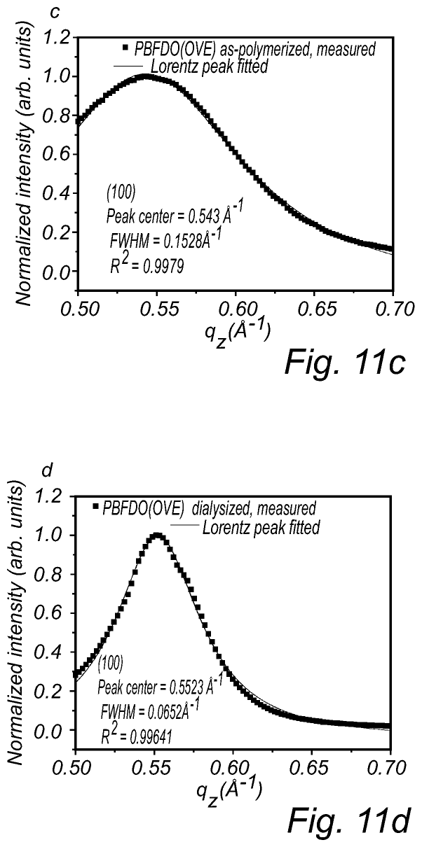

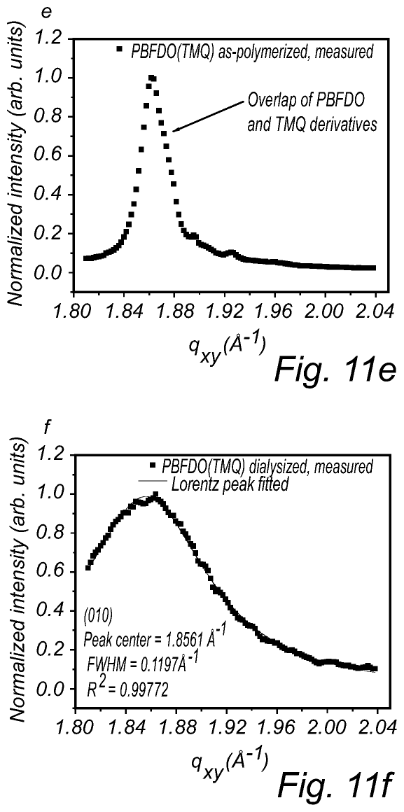

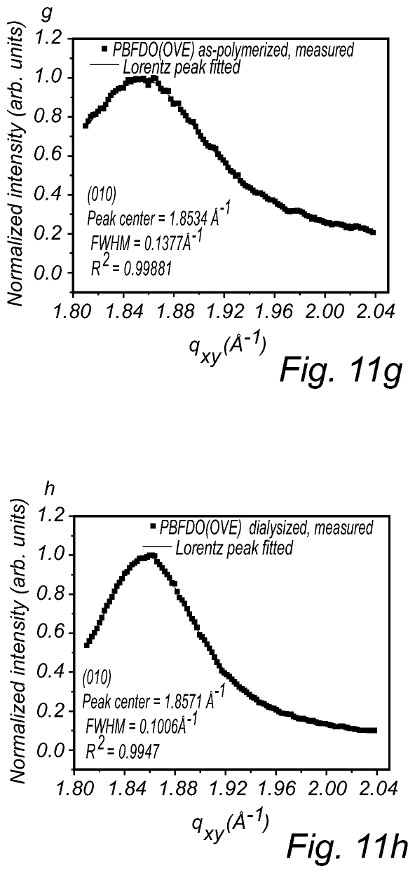

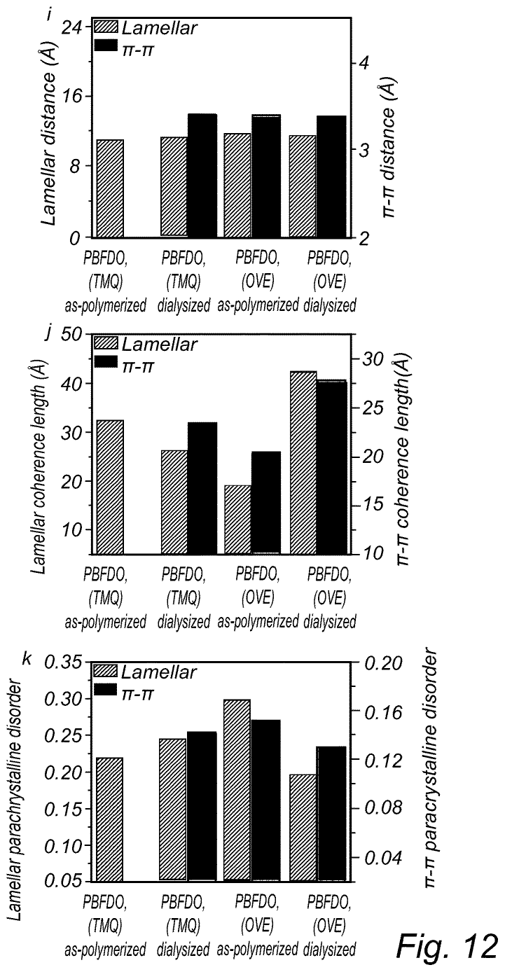

PBFDO thin film microstructure was investigated using grazing-incidence wide-angle X-ray scattering (GIWAXS) and atomic force microscopy (AFM) (FIG. 10a-j). GIWAXS analysis (FIG. 10a-f) reveals that PBFDO chains are primarily oriented edge-on on the substrate. All four PBFDOs, PBFDO (TMQ) as-polymerized (a), PBFDO (TMQ) dialyzed (b), PBFDO (OVE) as-polymerized (c), PBFDO (OVE) dialyzed (d) display strong TT-TT stacking (010) peaks located at around q_{xy}=1.85 Å⁻¹ (d-spacing=3.40 Å) (FIG. 11e-h). However, PBFDO (TMQ) as-polymerized (a) and PBFDO (TMQ) dialyzed (b) display a lamellar packing distance d-spacing=10.83 Å [(100) peak at q_{z}=0.58 Å⁻¹], which is similar to PBFDO (OVE) as-polymerized (c) and PBFDO (OVE) dialyzed (d)'s d-spacing=11.42 Å⁻¹ [(100) peak at q_{z}=0.55 Å] (FIG. 11a-d). Obviously, there are also strong TT-TT stacking (010) impurity peaks and lamellar (100) impurity peaks in PBFDO (TMQ) as-polymerized. This reveals that highly crystalline TMQ remains in PBFDO. Furthermore, PBFDO (OVE) as-polymerized shows shorter coherence length [20.3 Å for PBFDO (OVE) as-polymerized vs 23.4 Å for PBFDO (TMQ) dialyzed], and larger paracrystalline disorder [0.154 for PBFDO (OVE) as-polymerized vs 0.143 for PBFDO (TMQ) dialyzed] in IT-IT stacking (010) diffraction as shown in FIG. 12. The AFM analysis illustrates that PBFDO (TMQ) dialyzed (h), PBFDO (OVE) as-polymerized (i), PBFDO (OVE) dialyzed (j) films all have flat polycrystalline morphology (FIG. 10h-j). On the contrary, PBFDO (TMQ) as-polymerized (g) shows larger surface roughness and obvious aggregates.

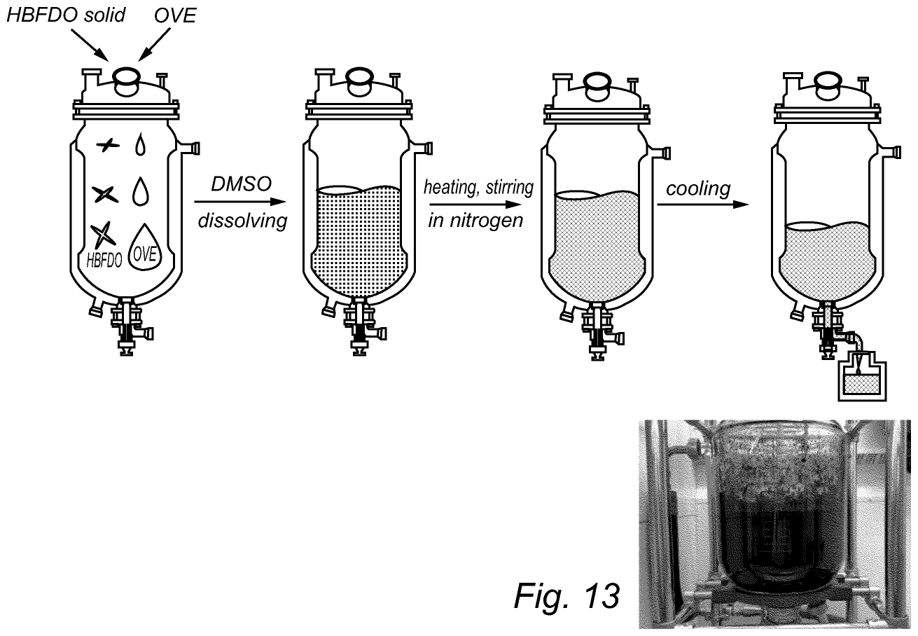

In summary, the present invention discloses a straightforward method for synthesizing conductive polymers by employing e.g. oxidized vitamin E (OVE) as a catalyst. The process involves a simple oxidation step to convert vitamin E into its oxidized form. The resulting polymer PBFDO achieved exceptional electrical conductivity, reaching an average conductivity of 1320 S cm⁻¹ and a maximum conductivity of 1800 S cm⁻¹. Additionally, the spin-coated film demonstrated remarkable air stability, retaining 97% of its conductivity after 180 days in ambient air. To demonstrate the simplicity of using OVE for catalyzing PBFDO polymerization, the production was upscaled using a 20 L reactor to generate 10 L of PBFDO ink (FIG. 13).

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

1. A method for manufacturing an ink comprising an n-type conducting polymer, said method comprising the steps of:
a) providing a catalyst or a catalyst precursor;
b) oxidizing said catalyst precursor by means of an oxidizing promoter, thus obtaining said catalyst;
c) adding a monomer to a solvent system comprising a polar aprotic solvent in the presence of said catalyst, thus providing a reaction solution; and
d) allowing the monomer to polymerize in said reaction solution thus obtaining an ink comprising the n-type conducting polymer,
wherein said catalyst is a quinone comprising at least one branched side chain comprising at least one chiral centre.

2. The method according to claim 1, wherein said at least one branched side chain is a saturated branched side chain.

3. The method according to claim 1, wherein said catalyst is vitamin E.

4. The method according to claim 3, wherein said vitamin E is selected from a group consisting of: α-tocopherol, β-tocopherol, γ-tocopherol, δ-tocopherol, α-tocotrienol, β-tocotrienol, γ-tocotrienol, δ-tocotrienol, and mixtures thereof.

5. The method according to claim 1, wherein said polar aprotic solvent is DMSO and said oxidizing promoter is hydrogen bromide (HBr).

6. The method according to claim 1, wherein said oxidizing promoter is an ionic liquid comprising a cation and an anion, and wherein said method further comprises a step of:
a′) electrolysing said reaction solution,
wherein said step a′) occurs simultaneously with or after step a).

7. The method according to claim 6, wherein said step a′) occurs using a nickel cathode and a carbon anode under voltage in a range from 4 to 6 V for a period in a range from 10 to 60 min.

8. The method according to claim 6, wherein said cation in said ionic liquid is selected from a group consisting of 1-ethyl-3-methylimidazolium (EMIM), 1-butyl-3-methylimidazolium (BMIM), 1-allyl-3-methylimidazolium (AMIM), 1-hexyl-3-methylimidazolium (HMIM), butyl-methyl pyrrolidinium (BMP), propyl-methyl pyrrolidinium (PMP), triethyl sulfonium, and mixtures thereof.

9. The method according to claim 6, wherein said anion is selected from a group consisting of chloride (Cl⁻), bromide (Br⁻), iodide (I⁻), acetate tetrafluoro (OAc), borate (BF₄⁻), hexafluoro phosphate (PF₆⁻), bis-trifluoromethanesulfonimide (TFSI), trifluoromethanesulfonate (OTf), dicyanamide (DCA), hydrogen sulphate (HSO₄⁻), ethyl sulphate (ESO₄⁻), thiocyanate (SCN), tosylate (OTs), mesylate (OMs), tetrachloro aluminate (AlCl₄⁻), diethyl phosphate (DEP), dimethyl phosphate (DMP), lactate (La), L-alanine anion (APP), and mixtures thereof.

10. The method according to claim 1, wherein said polar aprotic solvent is dimethyl sulfoxide (DMSO), dimethyl formamide (DMF), dimethyl acetamide (DMA), or a combination thereof.

11. The method according to claim 1, wherein the ratio between said oxidizing promoter and said catalyst is in the range from 0.1 to 100.

12. The method according to claim 1, wherein said step b) occurs at a temperature from 20° C. to 150° C.

13. The method according to claim 1, wherein said monomer is 3,7-dihydrobenzo[1,2-b: 4,5-b] difuran-2,6-dione (HBFDO), and wherein said n-type conducting polymer is poly(benzodifurandione) (PBFDO).

14. The method according to claim 1, wherein said method further comprises a step of:
e) removing said catalyst by extraction and recycling said catalyst.

15. An ink comprising an n-type conducting polymer, said ink manufactured by the method according to claim 1.

16. The method according to claim 11, wherein the ratio between said oxidizing promoter and said catalyst is in the range from 0.25 to 5.

17. The method according to claim 11, wherein the ratio between said oxidizing promoter and said catalyst is in the range from 1 to 3.
